(19) United States
(12) Patent Application Publication
(10) Pub. No.: US 2010/0211772 A1
(43) Pub. Date: Aug. 19, 2010

(54) Collaborative Reconciliation of Application Trustworthiness

(76) Inventors: Bjorn Johansson, Lund (SE); Jan Patrik Persson, Lund (SE); Bernard Smeets, Dalby (SE)

Correspondence Address: COATS & BENNETT, PLLC, 1400 Crescent Green, Suite 300, Cary, NC, 27518, US

(21) Appl. No.: 12/371,698

(22) Filed: Feb. 16, 2009

(51) Int. Cl. H04L 9/32; G06F 21/00

(52) U.S. Cl. 713/156; 726/21

(57) ABSTRACT

A mobile terminal receives trustworthiness information for a software application by receiving a voucher that indicates the trustworthiness of that application as represented by a third party. To ensure the integrity of this information, the mobile terminal authenticates the voucher and verifies that the software application is the one having its trustworthiness indicated by the voucher. Given such indications of trustworthiness, a user of the mobile terminal may decide whether install and run it. If decided in the affirmative, the user may form his or her own basis for the trustworthiness of the software application. Accordingly, the mobile terminal may also create a new voucher that indicates the trustworthiness of the software application as represented by the user. With third parties representing the trustworthiness of software applications in this manner, their development is not hindered by the imposition of security requirements on application developers.

### TECHNICAL FIELD

The present invention generally relates to methods and apparatus for receiving trustworthiness information for a software application, and particularly relates to receiving that information from a third party via a voucher.

### BACKGROUND

Development of software applications for mobile terminals often hinges on the cost and procedure required to implement and distribute them. Requiring an application developer to register with a Certificate Authority (CA) and digitally sign a software application before distribution, for example, hinders the number, quality, and diversity of software applications developed. Nevertheless, these security requirements are frequently imposed on application developers in order to provide assurances of application trustworthiness to their users (i.e. assurances regarding the presence or absence of malicious behavior of an application).

While it is desirable to eliminate this security burden on application developers to entice development of software applications, many alternative methods to provide users with information on application trustworthiness diminish user demand for those software applications. For instance, limiting the access of software applications to non-sensitive services of the mobile terminal platform gives users assurances of low security risks involved with an application, but renders such software applications undesirable for their rudimentary nature. On the other hand, requiring users themselves to police the access of software applications allows applications to have more sophisticated functionality, but regular prompting of the user upon each access attempt deters use of such applications.

Other attempts to eliminate this security burden on application developers resort to providing indirect, and thus potentially inaccurate, information on an application's trustworthiness. For example, solely relying on the “trust” of an application's source as an indication of the trustworthiness of that application fails to account for intermediate changes to the integrity of the application. This reliance, in addition, limits a user of a mobile terminal to acquiring software applications from certain “trusted” sources.

### SUMMARY

Methods and apparatus taught herein directly provide application trustworthiness information to users of software applications without imposing security requirements on application developers or diminishing user demand for those applications. Instead of limiting the platform access rights of software applications or the sources by which to obtain them, a user of a mobile terminal receives trustworthiness information for a software application from third parties. These third parties may include, for example, prior users of the software application who have created one or more vouchers indicating the trustworthiness of that application.

Thus, to receive trustworthiness information for a software application, a mobile terminal selectively receives a voucher that indicates the trustworthiness of a specific software application as represented by a specific third party. Upon receipt, the mobile terminal authenticates the voucher and verifies that the software application is the one having its trustworthiness indicated by the voucher.

In one embodiment, authentication of the voucher comprises verifying the integrity of the voucher against intermediate changes since its creation and verifying the identity of the specific third party who created it. By verifying the identity of the specific third party, the mobile terminal is configured to selectively receive a voucher only if it originated from a third party whose identity can be authenticated and who has been determined as trustworthy. Having confidence in the source of the trustworthiness information and certainty that the information has not been changed, a user of the mobile terminal may rely on that information for deciding whether to trust the software application.

Of course, the trustworthiness information indicated by the voucher may not be accurate if this software application has been changed since the third party represented its trustworthiness in the voucher. Accordingly, the mobile terminal also verifies that the software application is the one having its trustworthiness indicated by the voucher by, for example, comparing a software application identifier derived from the software application with a software application identifier included in the voucher. In one embodiment, the software application identifiers comprise software application hash values obtained through application of a software application hash function to the software application.

Given such indications on the trustworthiness of the software application, a user of the mobile terminal may decide whether to trust the software application, and if so, installs and runs it with certain access to the mobile terminal platform. The user is not thereafter prompted upon each subsequent attempt by the software application to access the mobile terminal platform.

Moreover, from installing and running the software application the user forms his or her own basis for the trustworthiness of the software application. Thus, in one embodiment the mobile terminal is further configured to create a new voucher that indicates the trustworthiness of the software application as represented by its user. Upon such creation, the mobile terminal may be configured to thereafter send the new voucher to others for use in an analogous manner as described above.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a voucher processing system in which the present invention may be used.

FIG. 2 is a block diagram illustrating one embodiment of a mobile terminal of the present invention.

FIG. 3 is a logic flow diagram of a method for receiving trustworthiness information for a software application from third parties.

FIG. 4 is a block diagram illustrating an alternative embodiment of a mobile terminal of the present invention.

### DETAILED DESCRIPTION

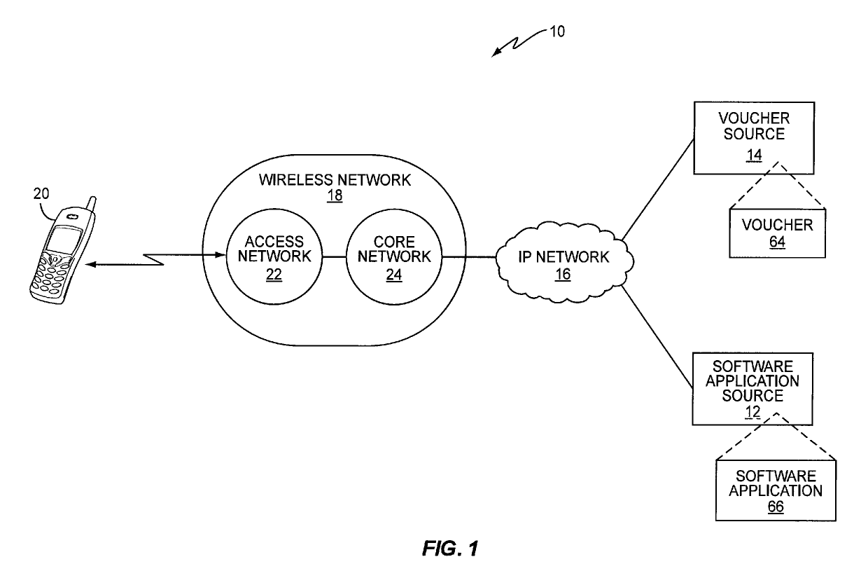

FIG. 1 illustrates a voucher processing system 10 for practicing one or more embodiments of the present invention. The voucher processing system 10 generally comprises a software application source 12, a voucher source 14, and a mobile terminal 20.

The software application source 12 provides a software application 66 to the mobile terminal 20. The software application 66 may have access to the services of the mobile terminal's 20 platform for enabling sophisticated functionality. However, the software application 66 has not been digitally signed by its developer, or if it has, the signature cannot be verified by the mobile terminal 20 as the signature of the application developer (e.g., with a Certificate Authority). That is, the application developer may distribute the software application 66 without these or similar indications of application trustworthiness. Furthermore, the application developer may even distribute the software application 66 via the software application source 12, which may be a source not trusted by a user of the mobile terminal 20. Nevertheless, a user of the mobile terminal 20 receives trustworthiness information for the software application 66 via the voucher source 14.

The voucher source 14 provides a voucher 64 to the mobile terminal 20. The voucher 64 indicates to a user of the mobile terminal 20 the trustworthiness of the software application 66 as represented by a specific third party. This specific third party may be, for example, a prior user of the software application 66 who subsequently created the voucher 64 representing its trustworthiness. In this case, multiple prior users of the software application 66 may have created multiple vouchers, including the voucher 64 and all indicating the trustworthiness of the software application 66. Therefore, although FIG. 1 explains the present invention with regard to the single voucher 64, those skilled in the art will appreciate that other vouchers also indicating the trustworthiness of the software application 66 may be discussed in the same manner as that of the voucher 64. In any event, given such indication, a user of the mobile terminal 20 decides whether to trust the software application 66, and if so, installs and runs it with certain access to the mobile terminal platform. A user of the mobile terminal 20 is not thereafter prompted upon each subsequent attempt by the software application 66 to access the mobile terminal platform.

More specifically, in this embodiment the mobile terminal 20 communicates with the software application source 12 and the voucher source 14 as described above by accessing a wireless network 18, which typically comprises an access network 22 and a core network 24. The wireless network 18 provides access to the software application source 12 and the voucher source 14 via an Internet Protocol (IP) network 16, such as the Internet or a similar network. Of course, those skilled in the art will readily appreciate that no particular communication interface standard is necessary for practicing the present invention. The wireless network 18, therefore, may be any one of a number of standardized network implementations, including GSM, CDMA (IS-95, IS-2000), TDMA (TIA/EIA-136), wide band CDMA (W-CDMA), GPRS, or other type of wireless communication network.

Moreover, it should be understood that while the software application source 12 and the voucher source 14 are illustrated as separate sources, those skilled in the art will appreciate that the software application 66 and the voucher 64 may indeed originate from a common source. Indeed, the sources 12 and 14 may comprise one or more web servers presenting the software application 66 and the voucher 64 to a user of the mobile terminal 20 for download over the Internet. Of course, while configuring the software application source 12 and the voucher source 14 as Internet-accessible sources is attractive in terms of flexibility and broad access, each of the software application source 12 and the voucher source 14 might be implemented as part of the wireless network 18. For example, either one of the software application source 12 or voucher source 14 may be implemented as a network entity within the core network 24. In that case, some security concerns associated with these sources 12 and 14 are eliminated, or at least minimized, but access to them may be more restricted. For example, the software application source 12 or voucher source 14 might be accessible only to subscribers of the wireless network 18.

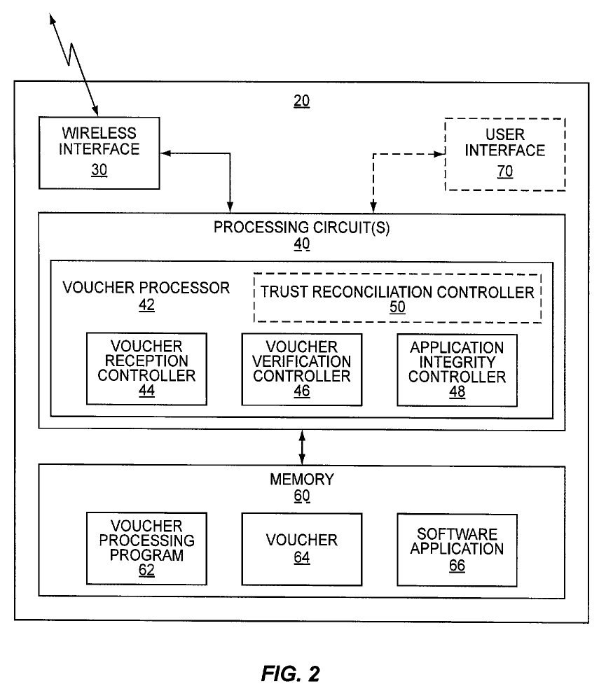

Those skilled in the art will also understand that the mobile terminal 20 represents essentially any device type having the appropriate wireless communication capabilities. Thus, the mobile terminal 20 might be an appropriately configured mobile telephone, personal digital assistant, hand-held, laptop, other personal computer device, or other type of electronic device. Regardless of the specific device type, however, the mobile terminal 20 is configured according to FIG. 2 for receiving trustworthiness information from third parties as described above.

In the embodiment of FIG. 2, the mobile terminal 20 generally comprises a wireless interface 30, one or more processing circuits 40, and a memory 60. The wireless interface 30 communicatively couples the mobile terminal 20 to the software application source 12 and the voucher source 14 via the wireless network 18. Accordingly, the wireless interface 30 is configured to selectively receive the software application 66 and the voucher 64. Upon receipt of the software application 66 and the voucher 64, the memory 60 is configured to store them in the mobile terminal 20 for processing by the one or more processing circuits 40.

With regard to processing of the voucher 64, the one or more processing circuits 40 are configured to authenticate the voucher 64. In one embodiment, for example, the one or more processing circuits 40 authenticate the identity of the specific third party indicating the trustworthiness of the software application 66 via the voucher 64. Alternatively or additionally, the one or more processing circuits 40 verify the integrity of the voucher 64, thereby ensuring a user of the mobile terminal 20 that the voucher 64 has not been subjected to intermediate changes. Such authentication and verification may be performed cryptographically using either public key or secret key cryptography.

Using secret key cryptography, for example, the one or more processing circuits 40 decrypt the voucher 64 using a secret key shared between a user of the mobile terminal 20 and the specific third party. If decrypted properly, a user of the mobile terminal 20 is ensured that the voucher 64 has not been subjected to intermediate changes. Although inherent properties of secret key cryptography prevent the identity of the specific third party from being securely authenticated, the burden of maintaining the shared secret is less than that of maintaining a public-private key pairing.

However, use of such a public-private key pairing by public key cryptography permits the verification of the integrity of the voucher 64 as well as the secure authentication of the identity of the specific third party. In this embodiment, the one or more processing circuits 40 verify a private key signature on the voucher 64 with a public key bound to the specific third party. If the private key signature is so verified, a user of the mobile terminal 20 is ensured both that the voucher 64 has not been subjected to intermediate changes and that it originated with the specific third party. The public-private key pair may be bound to the specific third party, of course, by either a Certificate Authority (CA) or a web of trust. Although this embodiment of the present invention shifts the traditional burden of maintaining a key pair binding from the application developer to one or more third parties vouching for the software application 66, the burden is spread among a large number of users of the already developed and distributed software application 66.

Moreover, in verifying the identity of the specific third party, a user of the mobile terminal 20 can establish a level of confidence for application trustworthiness information received from that specific third party (i.e. establish whether the specific third party is “trustworthy”). In one embodiment, for example, a user of the mobile terminal 20 has previously received vouchers indicating trustworthiness information for other software applications as represented by the specific third party, whose identity was verified. Based on these vouchers, the user chose to install or not to install the other software applications. If those other software applications behaved as represented by the specific third party, the user established a high level of confidence for application trustworthiness information received from that specific third party. Having determined that the specific third party is trustworthy, the user of the mobile terminal 20 may then confidently decide whether to install the software application 66 based on the trustworthiness information represented by the specific third party in the voucher 64.

Indeed, in one embodiment of the present invention the wireless interface 30 selectively receives only those vouchers originating from a third party whose identity can be authenticated and who has been determined as trustworthy. In this embodiment, the wireless interface 30 receives a list of third parties who have each represented the trustworthiness of the software application 66 in one or more vouchers. Based on this list, the one or more processing circuits 40 determine one or more third parties whose identity can be authenticated and who has been determined as trustworthy. The wireless interface 30, thereafter, receives only those vouchers indicating the trustworthiness of the software application 66 as represented by these determined third parties. Each of the received vouchers are processed as described above with regard to the voucher 64.

Having authenticated the voucher 64 as described above, the one or more processing circuits 40 also verify that the software application 66 is the one having its trustworthiness indicated by the voucher 64. That is, the one or more processing circuits 40 protect against intermediate changes made to a specific software application between the time the specific third party represented its trustworthiness via creating a voucher and the time a user of the mobile terminal 20 received it. In accounting for such intermediate changes, therefore, the one or more processing circuits 40 ensure that the trustworthiness information indicated by the voucher 64 corresponds with the precise behavior of the software application 66 received by the mobile terminal 20. Moreover, through this verification of the software application 66, a user of the mobile terminal 20 may receive the software application 66 from the software application source 12 even if it is not trusted by the user.

In one embodiment, for instance, a software application identifier included in the voucher 64 enables such verification of the software application 66. In this embodiment, when creating the voucher 64 for the software application 66, the specific third party obtains a software application identifier that uniquely identifies the software application 66. With this software application identifier included in the voucher 64, the one or more processing circuits 40 likewise derive a software application identifier for the software application 66 received. Upon comparison, if the software application identifier included in the voucher 64 corresponds to the software application identifier derived by the one or more processing circuits 40, the user can be assured the software application 66 received has not been subjected to intermediate changes.

The software application identifier included in the voucher 64 may be, for example, a software application hash value obtained by the specific third party applying a software application hash function to the software application 66. In this embodiment, therefore, the voucher 64 also specifies the software application hash function corresponding to the software application hash value included in the voucher 64. Given this software application hash function specified by the voucher 64, the one or more processing circuits 40 apply it to the software application 66 received to obtain a derived software application hash value. If the software application hash value included in the voucher 64 corresponds to this software application hash value derived by the one or more processing circuits 40, the user can be assured the software application 66 received has not been subjected to intermediate changes. Of course, those skilled in the art will appreciate that the present invention is not limited to use of hash values and functions, but rather, may utilize any technology capable of uniquely identifying the software application 66.

Those skilled in the art will also appreciate that the present invention is not limited by the manner in which the one or more processing circuits 40 are configured to verify the software application 66 and authenticate the voucher 64 as described above. Indeed, in one embodiment the one or more processing circuits 40 are configured to do so by executing a voucher processing program 62 stored in the memory 60, thereby creating a voucher processor 42. In this embodiment, the voucher processor 42 functionally comprises a voucher reception controller 44, a voucher verification controller 46, and an application integrity controller 48. Functionally, therefore, the voucher reception controller 44 regulates the selective reception of the voucher 64 via the wireless interface 30. Upon such receipt, the voucher verification controller 46 authenticates the voucher 64 as described above, while the application integrity controller 48 verifies that the software application 66 is the one having its trustworthiness indicated by the voucher 64.

Regardless of how the one or more processing circuits 40 are configured, with assurances of the integrity of the software application 66 and the authenticity of the voucher 64, a user of the mobile terminal 20 may decide whether to trust (i.e., install and run) the software application 66 based on the trustworthiness information indicated by the voucher 64. In one embodiment, the mere existence of the voucher 64 indicates an endorsement of the trustworthiness of the software application 66 (i.e. vouchers are not created to criticize the trustworthiness of software applications). In this case, a user's decision whether to trust the software application 66 only depends on his or her level of confidence in the specific third party and the existence of any additional vouchers that indicates further endorsement of the trustworthiness of the software application 66.

In an alternative embodiment, however, a user's decision whether to trust the software application 66 also depends on more detailed trustworthiness information indicated by the voucher 64. In this embodiment, the voucher 64 indicates either an endorsement or a criticism of the trustworthiness of the software application 66. Of course, the endorsement or criticism may be scaled or weighted to indicate varying degrees thereof.

Whether the voucher 64 indicates endorsement or criticism may be determined autonomously by the one or more processing circuits 40. Indeed in this case, the one or more processing circuits 40 may even autonomously reconcile the endorsements and criticisms of a plurality of vouchers for determining whether to trust the software application 66. For example, if the endorsements indicated by the plurality of vouchers outweigh the criticisms, the one or more processing circuits 40 may so advise a user of the mobile terminal 20 or install the software application 64 without further input from the user. When configured via execution of the voucher processing program 62 shown in FIG. 2, the voucher processor 42 may further include a trust reconciliation controller 50 for autonomously reconciling vouchers in this way. Alternatively or additionally, the mobile terminal 20 may further comprise a user interface 70 for outputting to a user human-readable comments included in the voucher that indicate such endorsement or criticism.

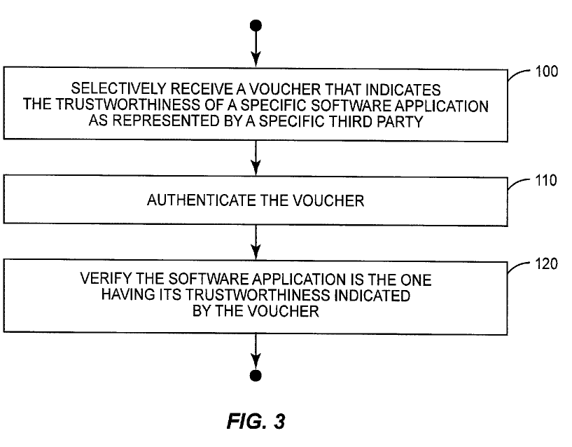

With the above points of variation and implementation in mind, those skilled in the art will appreciate that the mobile terminal 20 generally performs the method illustrated in FIG. 3 for receiving trustworthiness information for the software application 66 from third parties. According to FIG. 3, the wireless interface 30 selectively receives the voucher 64 that indicates the trustworthiness of a specific software application as represented by a specific third party (Block 100). The one or more processing circuits 40 authenticate the voucher 64 (Block 110) and verify the software application 66 is the one having its trustworthiness indicated by the voucher 64 (Block 120). If a user of the mobile terminal 20 decides to trust the software application 66 based on the trustworthiness information indicated by the voucher 64, the user installs and runs it.

From installing and running the software application 66, a user of the mobile terminal 20 forms his or her own basis for the trustworthiness of the software application 66. Thus, in one embodiment the one or more processing circuits 40 are further configured to create a new voucher that indicates the trustworthiness of the software application 66 as represented by its user. As alluded to in the above description, such creation may entail the one or more processing circuits 40 processing the software application 66 to obtain a distinct software application identifier and including it within the new voucher. This distinct software application identifier uniquely identifies the software application 66 installed and run by the user and may be, but does not have to be, identical to the software application identifier included in the voucher 64 received by that user. For example, the one or more processing circuits 40 may be configured to create the new voucher by applying to the software application 66 the same software application hash function specified in the voucher 64. Of course, those skilled in the art will readily appreciate that the distinct software application identifier used for creating the new voucher is not limited to being the same as that included in the voucher 64.

Creation of the new voucher may also entail the one or more processing circuits 40 signing the new voucher using either public key cryptography or secret key cryptography. If the new voucher is signed using secret key cryptography, for example, the one or more processing circuits 40 are configured to sign the new voucher with a secret key shared between the user of the mobile terminal 20 and others. If the new voucher is signed using public key cryptography, however, the one or more processing circuits 40 are configured to sign the new voucher with a private key signature that may be verified by others using a corresponding public key. In either case, the one or more processing circuits 40 permit others to authenticate the integrity of the new voucher and/or verify the identity of the user of the mobile terminal 20.

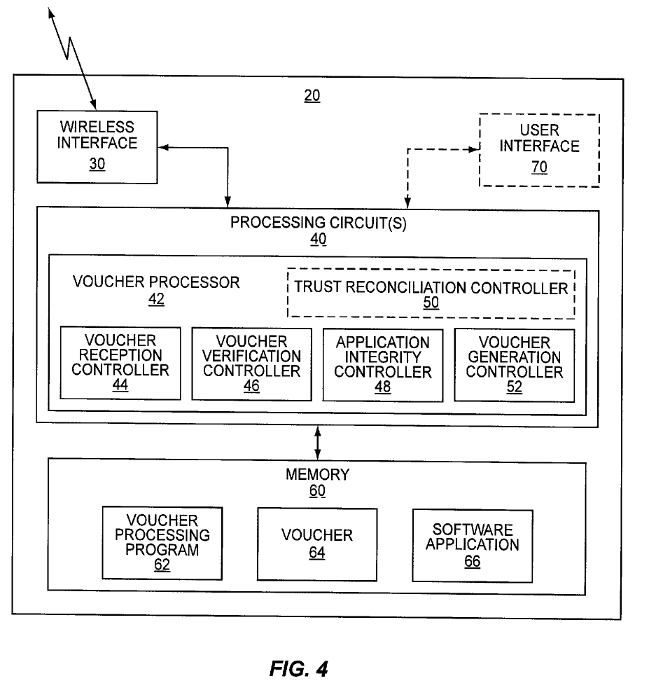

To create a new voucher as described above, in one embodiment, the mobile terminal 20 is modified as in FIG. 4. In FIG. 4, the voucher processing program 62 is modified from that of FIG. 2 to, when executed by the one or more processing circuits 40, create a voucher processor 42 that includes a voucher generation controller 52. This voucher generation controller 52 creates a new voucher that indicates the trustworthiness of the software application 66 as represented by a user of the mobile terminal 20. To provide protection against the use of malicious programs that would create new vouchers without the user's authorization, the voucher generator controller 52 is executed in an environment separate from the environment in which the software application 66 is executing. Techniques to realize such separate environments include, for example, hypervisor and virtualization techniques. Nevertheless, upon such creation, the wireless interface 30 may be configured to thereafter send the new voucher to the voucher source 14 for use by others in an analogous manner as described above. Of course, those skilled in the art will appreciate that the present invention is not limited by the manner in which the one or more processing circuits 40 are configured to create the new voucher.

Furthermore, it should be understood that the foregoing description and the accompanying drawings represent non-limiting examples of the methods and individual apparatuses taught herein. As such, the present invention is not limited by the foregoing description and accompanying drawings. Instead, the present invention is limited only by the following claims and their legal equivalents.

What is claimed is:

1. A method for receiving trustworthiness information for a software application from third parties, comprising:
selectively receiving a voucher that indicates the trustworthiness of a specific software application as represented by a specific third party;
authenticating the voucher; and
verifying said software application is the one having its trustworthiness indicated by the voucher.

2. The method of claim 1, wherein verifying said software application is the one having its trustworthiness indicated by the voucher comprises processing said software application to obtain a derived software application identifier and comparing the derived software application identifier with a software application identifier included in the voucher.

3. The method of claim 2, wherein processing said software application comprises applying a software application hash function specified in the voucher to said software application to obtain a derived software application hash value and comparing the derived software application identifier with a software application identifier included in the voucher comprises comparing the derived software application hash value to a software application hash value included in the voucher.

4. The method of claim 1, wherein authenticating the voucher comprises at least one of cryptographically verifying the integrity of the voucher and cryptographically authenticating the identity of the specific third party, said cryptographic verification and authentication performed using either public key or secret key cryptography.

5. The method of claim 1, wherein selectively receiving a voucher comprises receiving a voucher only if it originated from a third party whose identity can be authenticated and who has been determined as trustworthy.

6. The method of claim 1, further comprising outputting to a user human-readable comments included in the voucher that indicate either an endorsement or a criticism of the trustworthiness of said application.

7. The method of claim 1, wherein a voucher indicates either an endorsement or criticism of the trustworthiness of said application, and further comprising autonomously reconciling the endorsements and criticisms of a plurality of vouchers for determining whether to trust said application.

8. The method of claim 1, further comprising creating a new voucher that indicates the trustworthiness of said software application as represented by a user.

9. The method of claim 8, wherein creating the new voucher comprises processing said software application to obtain a distinct software application identifier and including within the new voucher the distinct software application identifier.

10. The method of claim 8, wherein creating the new voucher comprises signing the new voucher using either public key cryptography or secret key cryptography.

11. A mobile terminal configured to enable reception of trustworthiness information for a software application from third parties, comprising:
a wireless interface for communicatively coupling the mobile terminal to a voucher source via a wireless network and configured to selectively receive a voucher that indicates the trustworthiness of a specific software application as represented by a specific third party;
a memory configured to store one or more vouchers and said software application; and
one or more processing circuits communicatively coupled to the memory and the wireless interface, and configured to:
authenticate the voucher; and
verify said software application is the one having its trustworthiness indicated by the voucher.

12. The mobile terminal of claim 11, wherein the memory is further configured to store a voucher processing program and wherein the one or more processing circuits are configured to authenticate the voucher and verify said software application by executing the voucher processing program.

13. The mobile terminal of claim 11, wherein the one or more processing circuits are configured to verify said software application is the one having its trustworthiness indicated by the voucher via processing said software application to obtain a derived software application identifier and comparing the derived software application identifier with a software application identifier included in the voucher.

14. The mobile terminal of claim 13, wherein the one or more processing circuits are configured to process said software application by applying a software application hash function specified in the voucher to said software application to obtain a derived software application hash value and wherein the one or more processing circuits are configured to compare the derived software application identifier with a software application identifier included in the voucher by comparing the derived software application hash value to a software application hash value included in the voucher.

15. The mobile terminal of claim 11, wherein the one or more processing circuits are configured to authenticate the voucher by at least one of cryptographically verifying the integrity of the voucher and cryptographically authenticating the identity of the specific third party, the one or more processing circuits performing said cryptographic authentication and verification using either public key or secret key cryptography.

16. The mobile terminal of claim 11, wherein the wireless interface is configured to selectively receive a voucher by receiving a voucher only if it originated from a third party whose identity can be authenticated by the one or more processing circuits and who has been determined as trustworthy.

17. The mobile terminal of claim 11, further comprising a user interface configured to output to a user human-readable comments included in the voucher that indicate either an endorsement or a criticism of the trustworthiness of said application.

18. The mobile terminal of claim 11, wherein a voucher indicates either an endorsement or criticism of the trustworthiness of said application, and wherein the one or more processing circuits are further configured to autonomously reconcile the endorsements and criticisms of a plurality of vouchers for determining whether to trust said application.

19. The mobile terminal of claim 11, wherein the one or more processing circuits are further configured to create a new voucher that indicates the trustworthiness of said software application as represented by a user.

20. The mobile terminal of claim 19, wherein the one or more processing circuits are configured to create the new voucher by processing said software application to obtain a distinct software application identifier and including within the new voucher the distinct software application identifier.

21. The mobile terminal of claim 19, wherein the one or more processing circuits are configured to create the new voucher by signing the new voucher using either public key cryptography or secret key cryptography.
